(19) United States
(12) Patent Application Publication
(10) Pub. No.: US 2023/0228369 A1
(43) Pub. Date: Jul. 20, 2023

(54) STACKABLE AND NESTABLE SUPPORT APPARATUS

(71) Applicant: James Barry Waddell, Frankfort, KY (US)

(72) Inventor: James Barry Waddell, Frankfort, KY (US)

(21) Appl. No.: 17/648,136

(22) Filed: Jan. 17, 2022

(51) Int. Cl. F16M 11/24

(52) U.S. Cl. CPC F16M 11/24

(57) ABSTRACT

A stackable and nestable support apparatus the stackable and nestable support apparatus of the present invention includes multiple support elements that are stackable to provide for support base of varied elevations. In a stacked, supporting position, one or more of the support elements are selected for emplacement between a foot of a leveling jack utilized to level the recreational vehicle (RV). The number and orientation of the one or more support elements are selected based on a needed vertical support elevation between the foot of the leveling jack and the terrain T in which the RV is emplaced. The multiple support elements are also nestable to reduce storage space when not in use.

### BACKGROUND OF THE INVENTION

The present invention relates to support elements, and more particularly to supports for supporting a leveling jack, such as used to support a recreational vehicle (RV).

For RV enthusiasts, leveling jacks are utilized to support the RV at a campsite or other location where the RV will be parked. The leveling jacks are typically attached to the RV where they may be movable between a stowed, traveling position, to a deployed supporting position. As their name implies, the leveling jacks are utilized to level the RV across the terrain in which they will be emplaced. Leveling in each of a longitudinal and lateral of the RV is desirable for comfort as well as proper operation of life support systems within the RV. This is especially true for refrigeration systems utilizing anhydrous ammonia refrigeration systems.

Leveling jacks will have a limited range of motion for leveling the RV. As such, the RV enthusiast may need to emplace additional blocks or shoring beneath one or more foot pads of the leveling jack to properly level the RV, particularly where the emplacement is situated over uneven terrain. In other circumstances, limiting the travel of the leveling jacks can improve the stability of the RV supported on the leveling jacks. Providing additional blocks for a supported elevation can improve this stability.

As will be appreciated, the RV has limited storage space for the carriage of both personal items and equipment for operating the RV. Accordingly, it is desirable that any shoring, blocks, and other equipment occupy a limited space when not utilized, particularly in transit.

As can be seen, there is a need for improved stackable support elements for supporting a leveling jack while requiring minimum storage space when they are not in use.

### SUMMARY OF THE INVENTION

In one aspect of the present invention, a stackable and nestable support apparatus is disclosed. The stackable and nestable support apparatus includes a first support element having multiple first sidewalls oriented in a geometric shape. A base plate overlies a bottom edge of the multiple first sidewalls. A first interior cavity is defined by the multiple first sidewalls and the base plate. A first notch is defined in a top edge of each of the multiple first sidewalls at an intermediate position thereof. A third support element has multiple third sidewalls oriented in the geometric shape and a top plate overlying the multiple third sidewalls. The multiple third sidewalls and top plate define a third interior cavity. The multiple first sidewalls are dimensioned to be received within the third interior cavity in a nested condition corresponding to a lowest supporting elevation and is configurable in an intermediate supporting elevation with a corner of the multiple third sidewalls received and supported by the first notch when placed in a deployed condition.

In some embodiments, a second support element is provided having multiple second sidewalls oriented in the geometric shape. The multiple second sidewalls are dimensioned to be received within the first interior cavity of the first support element in the nested condition. Each of corner of the multiple second sidewalls are configured to be supported by the first notch in a maximum supporting elevation in the deployed condition. A second notch is defined in top edge of each of the multiple second sidewalls at an intermediate position thereof. The second notch configured to receive the corner of the multiple third sidewalls when the second support element is interposed between the first support element and the third support element in the maximum supporting elevation.

In other aspects of the invention, a stackable and nestable support apparatus includes a first support element having multiple first sidewalls oriented in a geometric shape. A base plate overlying a bottom edge of the multiple first sidewalls. The multiple first sidewalls and the base plate define a first interior cavity. A second support element having multiple second sidewalls oriented in the geometric shape, with the multiple second sidewalls dimensioned to be received within the first interior cavity of the first support element in a nested condition. A third support element has multiple third sidewalls oriented in the geometric shape. A top plate overlies the multiple third sidewalls. The multiple third sidewalls and the top plate define a third interior cavity dimensioned to receive each of the multiple first sidewalls and the multiple second sidewalls when oriented in a stowed and nested condition, corresponding to a lowest supporting elevation. Each of the first support element, the second support element, and the third support element are configurable at a maximum supporting elevation by an offset rotation of the first support element, the second support element, and the third support element, such that a top edge of a subjacent multiple sidewalls supports a bottom edge of an overlying multiple sidewalls.

In other aspects of the invention, a stackable and nestable support apparatus, includes a first support element having multiple first sidewalls oriented in a geometric shape. A base plate overlies a bottom edge of the multiple first sidewalls. A first interior cavity is defined by the multiple first sidewalls and the base plate. A first notch is defined in a top edge of each of the multiple first sidewalls at an intermediate position thereof. A third support element has multiple third sidewalls oriented in the geometric shape. A top plate overlies the multiple third sidewalls. The multiple third sidewalls and the top plate define a third interior cavity. The first support element and the third support element are configurable between a stowed and nested condition in which the geometric shape is aligned and a deployed condition in which the geometric shape is rotationally offset such that a corner of the multiple third sidewalls is received and supported by an indexing with the first notch when placed in a deployed condition.

In some embodiments, a second support element having multiple second sidewalls oriented in the geometric shape is included. The multiple second sidewalls are dimensioned to be received within each of the first interior cavity and the third interior cavity in the stowed and nested condition. Each of the first support element, the second support element, and the third support element are configurable in the stowed and nested condition in which the geometric shape is aligned, and a deployed condition in which the second support element is interposed between the first support element and the third support element, and the geometric shape of the second support element is rotationally offset with each of the first support element and the third support element.

These and other features, aspects and advantages of the present invention will become better understood with reference to the following drawings, description and claims.

### BRIEF DESCRIPTION OF THE DRAWINGS

FIG. 1 is a perspective view of the stackable and nestable support apparatus, shown in use.

FIG. 2 is an exploded view of the stackable and nestable support apparatus.

FIG. 3 is a section view taken along 3-3 in FIG. 1.

FIG. 4 is a section view taken along 4-4 in FIG. 3.

FIG. 5 is a perspective view of the stackable and nestable support apparatus, shown with rotation of the middle element 20.

FIG. 6 is a perspective view of the stackable and nestable support apparatus, shown in the stowed and nested condition.

FIG. 7 is a section view taken along 7-7 in FIG. 6

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

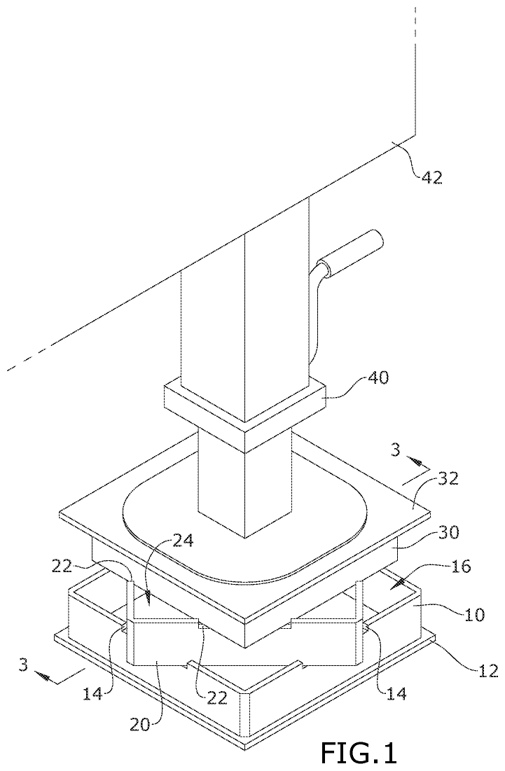

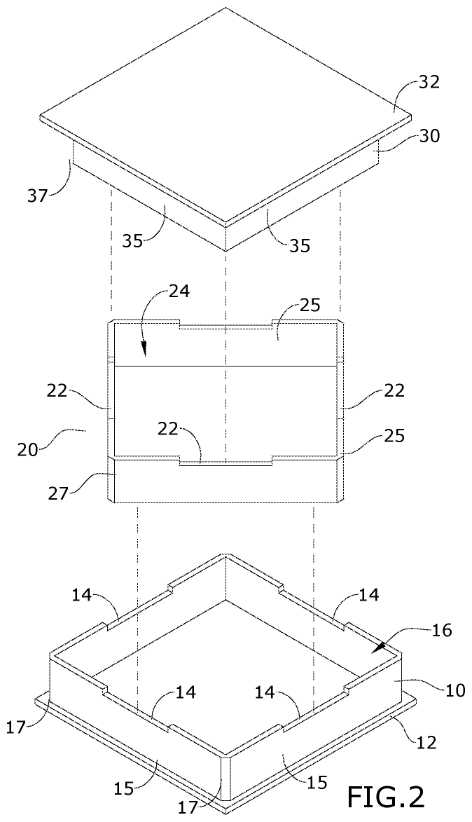

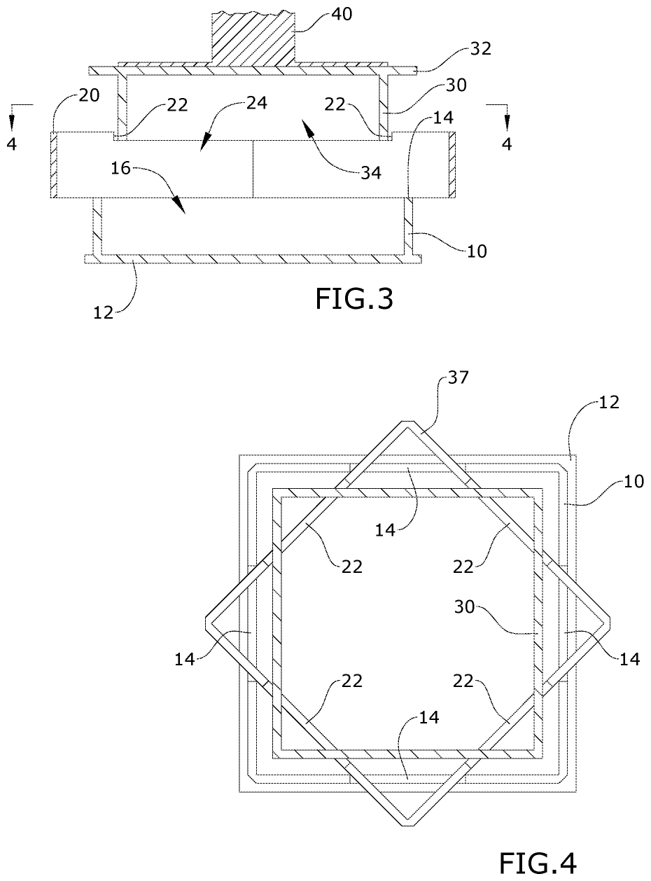

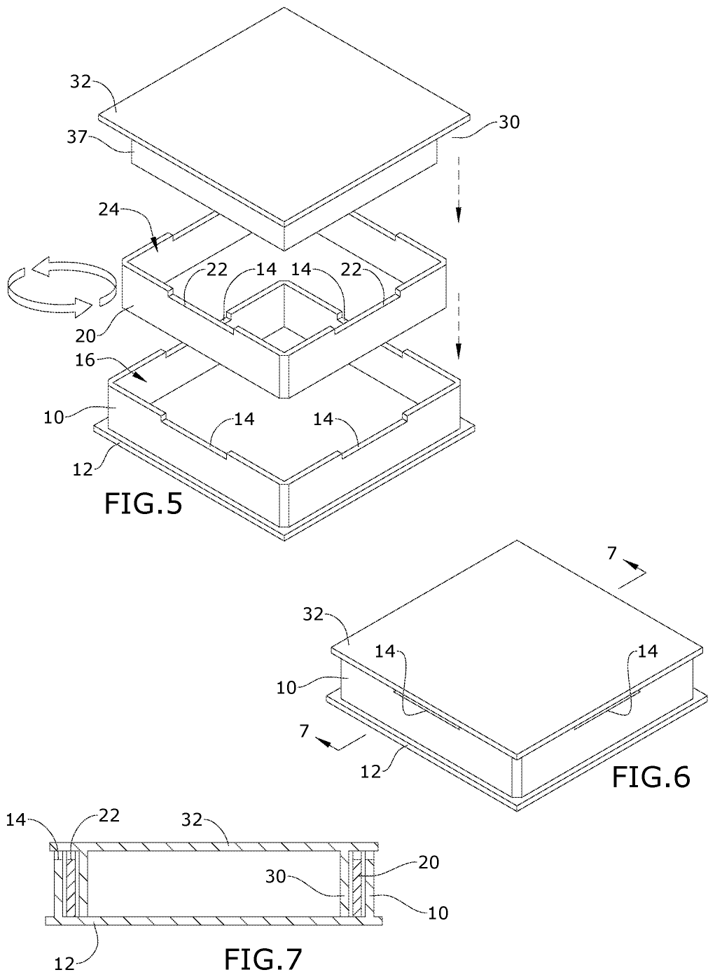

Broadly, embodiments of the present invention provide a stackable and nestable support apparatus for use in leveling an RV. As seen in reference to the drawings of FIGS. 1-7, the stackable and nestable support apparatus of the present invention includes multiple support elements 10, 20, 30 that are stackable to provide for support base of varied elevations. In a stacked, supporting position, one or more of the support elements 10, 20, 30 are selected for emplacement between a foot 44 of a leveling jack 40 utilized to level the RV 42. The number and orientation of the one or more support elements 10, 20, 30 are selected based on a needed vertical support elevation between the foot 44 of the leveling jack 40 and the terrain T in which the RV is emplaced. The multiple support elements 10, 20, 30 are also nestable to reduce storage space when not in use. The multiple support elements include a first support element 10, a second support element 20, and a third support element 30.

A first support element 10 includes a base 12 overlying multiple first sidewalls 15 oriented in a geometric shape. An edge of the base 12 may extend past the multiple sidewalls 15, defining a lip to facilitate grasping, positioning, and lifting of the first support element. In the non-limiting embodiment shown, the geometric shape is a square. As will be appreciated, other shapes such as a triangle, a rectangle, a hexagon, and the like are also suitable for practicing aspects of the invention.

The base 12 and the multiple first sidewalls 15 define a first interior cavity 16, within which a second support element 20 and sidewalls 35 of a third support element 30 are contained, when oriented in the nested configuration.

Multiple notches 14 are defined in a spaced apart relation about an edge of the multiple sidewalls 15 opposite from the base 12. At least one notch 14 is provided for receiving a sidewall corner 27, 37 of one of the second support element 20 or the third support element 30 in an overlapping orientation. The notch 14 is defined at an intermediate portion of the respective first sidewall 15. Preferably, each notch 14 has a width corresponding with a width of the sidewall corner 27, 37 when the placed atop the first support element 10 so that the second support element 20 or the third support element 30 is received in an indexed supporting relation atop the first support element 10.

The second support element 20 has multiple second sidewalls 25 defined in a geometric shape corresponding with the first support element 10 and is dimensioned to be received within the interior cavity 16 of the first support element 10. Each second sidewall corner 27 is chamfered, rounded, or flattened to facilitate nesting of the second support element within the interior cavity 16 of the first support element 10. A top edge of the second sidewall 25 includes a notch 24 disposed at an intermediate position of each of the respective second sidewalls 25. As with the notch 14 of the first support element 10, the notches 24 of the second support element 20 have a width corresponding to a width of a corner of the third support element 30, such that the corners 37 of the third support element 30 may be coupled in an indexed relation with the notch 24. The second support element 20 is utilized when a maximum vertical elevation is desired for supporting the RV 42 on the terrain T.

The third support element 30 has multiple second sidewalls 35 arranged in a geometric shape corresponding with the first support element 10 and the second support element 20. The third support element 30 also has a top plate 34 overlying the third multiple sidewalls 35. As with the bottom plate 12 of the first support element, the top plate 32 is dimensioned to overlap the third sidewalls 35 to facilitate grasping, positioning, and lifting the third support element 30. A length of the third sidewalls 35 may be selected to nest within the second sidewalls 25 of the second support element 20.

To emplace the support elements 10, 20, 30 for a maximum supporting elevation, the base 12 of the first support element 20 may be placed on a top surface of the terrain T with the notches 14 oriented upwardly. The second support element 20 is oriented such that the corners 27 between each of the multiple second sidewalls 25 are received within the notches 14 of the first support element 20. The second notches 24 are oriented upwardly. Once the second support element 20 has been placed, the corners 37 of the third support element 30 are oriented to be received within the second notches 24 of the second support element 20. The top plate 32 is oriented upwardly to support the placement of the support foot 44 of the leveling jack 42. As should be apparent from the present disclosure, the second support element 20 may be omitted, with the corners 37 of the third support element 30 received within the notches 14 of the first support element 10 for an intermediate support elevation. When omitted, the second storage element 20 may still be retained within the interior cavity 16 of the first support element.

To arrange the support elements in the stowed configuration, the RV is configured such that the foot 44 of the leveling jack 42 is not supported by the support apparatus. The first support element 10 is then positioned with its interior cavity 16 oriented to receive the second support element 20 within the interior cavity 16 in a nested configuration. The second support element 20 is rotated such that the geometric shapes are aligned and inserted within the interior cavity 16. In the non-limiting embodiment shown, the third support element 30 is then oriented such that the third sidewall 35 is received within the interior cavity 26 of the second support element and the interior cavity 16 of the first support element 10. In this configuration, the stackable and nestable support apparatus occupies a storage volume of roughly ⅓ of that required by each of the support elements 10, 20, 30 individually. In this configuration, the stackable and nestable support apparatus may also be used in a lowest support elevation for emplacement beneath the leveling jack 42.

Each of the support elements 10, 20, 30 may be constructed of a suitable material to support the RV when emplaced. The materials may include concrete, thermoplastics, metal, and composites. A height of each of the multiple first sidewalls, the multiple second sidewalls, and the multiple third sidewalls are selected to provide a desired support elevation when oriented in the deployed condition.

It should be understood, of course, that the foregoing relates to exemplary embodiments of the invention and that modifications may be made without departing from the spirit and scope of the invention as set forth in the following claims.

What is claimed is:

1. A stackable and nestable support apparatus, comprising:
a first support element having multiple first sidewalls oriented in a geometric shape, a base plate overlying a bottom edge of the multiple first sidewalls, an interior cavity defined by the multiple first sidewalls and the base plate, and a first notch defined in a top edge of each of the multiple first sidewalls at an intermediate position thereof; and
a third support element having multiple third sidewalls oriented in the geometric shape, and a top plate overlying the multiple third sidewalls, the multiple third sidewalls and top plate defining a third interior cavity, wherein the multiple first sidewalls are dimensioned to be received within the third interior cavity in a nested condition corresponding to a lowest supporting elevation, and configurable in an intermediate supporting elevation with a corner of the multiple third sidewalls received and supported by the first notch when placed in a deployed condition.

2. The stackable and nestable support apparatus of claim 1, further comprising:
a second support element having multiple second sidewalls oriented in the geometric shape, the multiple second sidewalls dimensioned to be received within the interior cavity of the first support element in the nested condition, and each of a corner of the multiple second sidewalls configured to be supported by the first notch in a maximum supporting elevation in the deployed condition; and
a second notch defined in top edge of each of the multiple second sidewalls at an intermediate position thereof, the second notch configured to receive the corner of the multiple third sidewalls when the second support element is interposed between the first support element and the third support element in the maximum supporting elevation.

3. The stackable and nestable support apparatus of claim 2, further comprising:
a chamfer defined along each corner of the multiple second sidewalls.

4. The stackable and nestable support apparatus of claim 1, wherein the base plate extends beyond the multiple first sidewalls, defining a first lip.

5. The stackable and nestable support apparatus of claim 1, wherein the top plate extends beyond the multiple third sidewalls, defining a third lip.

6. A stackable and nestable support apparatus, comprising:
a first support element having multiple first sidewalls oriented in a geometric shape, a base plate overlying a bottom edge of the multiple first sidewalls, the multiple first sidewalls and the base plate defining a first interior cavity,
a second support element having multiple second sidewalls oriented in the geometric shape, the multiple second sidewalls dimensioned to be received within the first interior cavity of the first support element in a nested condition; and
a third support element having multiple third sidewalls oriented in the geometric shape, a top plate overlying the multiple third sidewalls, the multiple third sidewalls and the top plate defining a third interior cavity dimensioned to receive each of the multiple first sidewalls and the multiple second sidewalls when oriented in a stowed and nested condition corresponding to a lowest supporting elevation, wherein each of the first support element, the second support element, and the third support element are configurable at a maximum supporting elevation by an offset rotation of the first support element, the second support element, and the third support element, such that a top edge of a subjacent multiple sidewall supports a bottom edge of an overlying multiple sidewall.

7. The stackable and nestable support apparatus of claim 6, further comprising:
a first notch defined in in the top edge of each of the multiple first sidewalls at an intermediate portion thereof; and
a second notch defined in the top edge of the multiple second sidewalls at an intermediate portion thereof.

8. The stackable and nestable support apparatus of claim 7, further comprising:
a chamfer defined in each corner of the multiple first sidewalls and each corner of the multiple second sidewalls.

9. The stackable and nestable support apparatus of claim 6, wherein each of the first support element, the second support element, and the third support element are configurable in an intermediate supporting elevation by a rotational offset of the first support element, the third support element, such that a top edge of the first support element is the subjacent multiple sidewall supports a bottom edge of the third support element is the overlying multiple sidewall.

10. A stackable and nestable support apparatus, comprising:
a first support element having multiple first sidewalls oriented in a geometric shape, a base plate overlying a bottom edge of the multiple first sidewalls, a first interior cavity defined by the multiple first sidewalls and the base plate, and a first notch defined in a top edge of each of the multiple first sidewalls at an intermediate position thereof; and
a third support element having multiple third sidewalls oriented in the geometric shape, and a top plate overlying the multiple third sidewalls, the multiple third sidewalls and top plate defining a third interior cavity, wherein the first support element and the third support element are configurable between a stowed and nested condition in which the geometric shape is aligned and a deployed condition in which the geometric shape is rotationally offset such that a corner of the multiple third sidewalls is received and supported by an indexing with the first notch when placed in a deployed condition.

11. The stackable and nestable support apparatus of claim 10, further comprising:
a second support element having multiple second sidewalls oriented in the geometric shape, the multiple second sidewalls dimensioned to be received within each of the first interior cavity the third interior cavity in the stowed and nested condition, wherein each of the first support element, the second support element, and the third support element are configurable in the stowed and nested condition in which the geometric shape is aligned, and a deployed condition in which the second support element is interposed between the first support element and the third support element, and the geometric shape of the second support element is rotationally offset with each of the first support element and the third support element.
